(19) United States
(12) Patent Application Publication
(10) Pub. No.: US 2021/0196054 A1
(43) Pub. Date: Jul. 1, 2021

(54) MATTRESS LIFTING DEVICE

(71) Applicant: Patient Positioning Systems, LLC, Annapolis, MD (US)

(72) Inventors: Daniel Gabbay, Arlington, VA (US); David C. Adams, Niceville, FL (US); Mark Ryan Slusar, Annapolis, MD (US)

(21) Appl. No.: 17/056,452

(22) PCT Filed: May 18, 2018
(86) PCT No.: PCT/US18/33329

§ 371 Date: Nov. 18, 2020

(51) Int. Cl. A47C 27/08; A47C 31/00

(52) U.S. Cl. CPC A47C 27/083; A47C 31/008; A47C 27/082

(57) ABSTRACT

An apparatus for lifting a mattress to an optimal work level so as to facilitate the bed making process. More specifically an apparatus for lifting a mattress, the apparatus including a generally rectangular ring shaped inflatable member with a generally constant cross section configured to be disposed between a mattress and a supporting structure of a bed in an unsecured manner; an air pump in fluid communication with the inflatable member, the air pump configured to inflate the inflatable member to a substantially uniform pressure throughout an entire perimeter of the inflatable member; a power supply in electrical communication with the air pump for providing power to operate the air pump; a switch in electrical communication between the power supply and the air pump configured for activating and deactivating the air pump; and a valve configured to control both inflation and deflation of the inflatable member.

### CROSS-REFERENCE TO RELATED APPLICATIONS

This application is a Unites States National stage application, filed under 35 U.S.C. § 371, of International Application PCT/US18/33329 entitled “MATTRESS LIFTING DEVICE” filed May 18, 2018 which is incorporated by reference herein and which this application claims the benefit thereof.

### FIELD OF THE INVENTION

The present invention relates, in general, to an aid in the bed making process and, more particularly, the present invention relates to a mattress lifting device that raises the mattress so as to eliminate the need for a person or persons to physically lift and manipulate a heavy mattress during the bed making process and enable the user to complete the bed making process while the mattress is still elevated on the air bladder or inflatable element.

### BACKGROUND OF THE INVENTION

Homemakers must regularly clean and change the sheets and linens on the beds in their homes, a task that necessarily involves repetitive lifting and manipulating a heavy, bulky mattress during the bed making process. Most homemakers, both young and old, find that lifting a heavy mattress with one hand and positioning the sheets and blankets with the other hand is next to impossible unless they have help. Even with two persons working together, making a bed is a strenuous task.

Likewise, hotel housekeepers at hotels, motels and inns must routinely change the linen on many beds every day. The stress and strain associated with the repetitive lifting of heavy mattresses during the bed making process eventually takes a toll on the worker in the form of lifting injuries, work loss, and even workman's compensation insurance claims in the case of commercial establishments.

Accordingly, it would be advantageous to develop an apparatus, which (1) elevates the mattress throughout the bed making task, and (2) provides a means to conveniently secure the bed linen and blankets under the mattress while the mattress is still supported at an optimal work level by the inflated air bladder. Such an apparatus ensures that the bed making task can be completed while the mattress is raised to an optimal work level. In most cases, a well designed apparatus also enables a single person to do the job by himself/herself without the need for an assistant.

### SUMMARY OF THE INVENTION

In one embodiment the present invention is an apparatus for lifting a mattress, the apparatus including a generally rectangular ring shaped inflatable member with a generally constant cross section configured to be disposed between a mattress and a supporting structure of a bed in an unsecured manner; an air pump in fluid communication with the inflatable member, the air pump configured to inflate the inflatable member to a substantially uniform pressure throughout an entire perimeter of the inflatable member; a power supply in electrical communication with the air pump for providing power to operate the air pump; a switch in electrical communication between the power supply and the air pump configured for activating and deactivating the air pump; and a valve configured to control both inflation and deflation of the inflatable member. In another embodiment, the switch is a reed switch. In yet another embodiment the switch is a reed switch which is configured to be normally open. In still another embodiment a magnet for the reed switch, and clip are configured to receive the magnet in a position so that a magnetic field of the magnet is applied to the reed switch. In still yet another embodiment the switch is configured to be operated via a wirelessly connected remote control. In another embodiment the generally rectangular ring shaped inflatable member further includes an inflatable cross member that bisects the ring shape of the inflatable member. In another embodiment the generally rectangular ring shaped inflatable member further includes an inflatable cross member with a generally constant cross section that bisects the ring shape of the inflatable member. In another embodiment the inflatable member further includes a textured surface configured to keep the inflatable member in place between the mattress and the supporting structure. In another embodiment the inflatable member further includes an inflatable peripheral bulge disposed and configured to contact the mattress when inflated. In another embodiment the inflatable member includes at least two generally rectangular ring shaped inflatable members in fluid communication with each other, and the at least two generally rectangular ring shaped inflatable members are disposed in a stacked orientation. In another embodiment the at least two generally rectangular ring shaped inflatable members are connected in fluid communication via at least one one-way valve. In another embodiment the supporting structure is a box spring. In another embodiment the inflatable member is attached and integrated into the supporting structure.

In another embodiment the present invention is an apparatus for lifting a mattress, the apparatus including a generally rectangular ring shaped inflatable member with an inflatable cross member with a generally constant cross section that bisects the ring shape of the inflatable member configured to be disposed between a mattress and a supporting structure of a bed in an unsecured manner; an air pump in fluid communication with the inflatable member, the air pump configured to inflate the inflatable member to a substantially uniform pressure throughout an entire perimeter of the inflatable member; a power supply in electrical communication with the air pump for providing power to operate the air pump; a switch in electrical communication between the power supply and the air pump configured for activating and deactivating the air pump; and a valve configured to control both inflation and deflation of the inflatable member. In another embodiment the inflatable member further includes an inflatable peripheral bulge disposed and configured to contact the mattress when inflated. In another embodiment the inflatable member comprises at least two generally rectangular ring shaped inflatable members in fluid communication with each other, and the at least two generally rectangular ring shaped inflatable members are disposed in a stacked orientation. In another embodiment the inflatable member further includes an inflatable peripheral bulge disposed and configured to contact the mattress when inflated, and the inflatable member includes at least two generally rectangular ring shaped inflatable members in fluid communication with each other, and the at least two generally rectangular ring shaped inflatable members are disposed in a stacked orientation.

### OBJECTS OF THE INVENTION

It is, therefore, one of the primary objects of the present invention to provide an apparatus that can lift the mattress when needed. Another object of the present invention is to provide an apparatus that can lift a mattress to a specific height as desired by a user. Still another object of the present invention is to provide an apparatus that can be stored in place under a mattress. Yet another object of the present invention is to provide an apparatus that can be sized to fit different size mattresses.

Another object of the present invention is to provide an apparatus that is inflated by either an electric air pump or a manual air pump.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE SEVERAL VIEWS OF THE DRAWINGS

FIG. 1 is a side perspective view of a mattress and box springs with the inflatable member according to an embodiment of the invention.

FIG. 2 is a side perspective view of the mattress and box springs with the uninflated apparatus shown in FIG. 1 disposed there between.

FIG. 3 is a plan view of the inflatable apparatus for raising a mattress according to an embodiment of the invention.

FIG. 4 is a cross sectional view of inflatable member along line A-A shown in FIG. 3 according to an embodiment of the invention.

FIG. 5 is a cross sectional view of inflatable member along line A-A shown in FIG. 3 according to another embodiment of the invention.

FIG. 6 is a cross sectional view of inflatable member along line B-B shown in FIG. 3 according to another embodiment of the invention.

FIG. 7 is a side perspective view of a mattress and box springs with a multilayer inflatable member according to an embodiment of the invention.

FIG. 8 is an end perspective view of a mattress and box springs with the multilayer inflatable member shown in FIG. 7.

FIG. 9 is a cross sectional view of the multilayer inflatable member along line C-C shown in FIG. 8 according to embodiment of the invention.

FIG. 10 is a cross sectional view of the multilayer inflatable member along line D-D shown in FIG. 8 according to embodiment of the invention.

FIG. 11 is a side perspective view of a mattress and box springs with a multilayer inflatable member according to an embodiment of the invention.

FIG. 12 is a cross sectional view of the multilayer inflatable member along line E-E shown in FIG. 11 according to embodiment of the invention.

FIG. 13 is a cross sectional view of the multilayer inflatable member along line F-F shown in FIG. 11 according to embodiment of the invention.

FIG. 14 is a schematic of the steps for operating the present invention according to an embodiment.

FIG. 15 is a side view of a hidden reed switch with retention plate for operating the present invention according to an embodiment

FIG. 16 is an exterior view of a hidden reed with retention switch shown in FIG. 15.

FIG. 17 is a side view of a hidden reed switch with contact plate for operating the present invention according to an embodiment

FIG. 18 is a side view of the hidden reed switch with contact plate shown in FIG. 17 being deactivated.

### DETAILED DESCRIPTION OF THE INVENTION

Prior to proceeding with the more detailed description of the present invention it should be noted that, for the sake of clarity, identical components which have identical functions have been designated by identical reference numerals throughout the several views illustrated in the drawings.

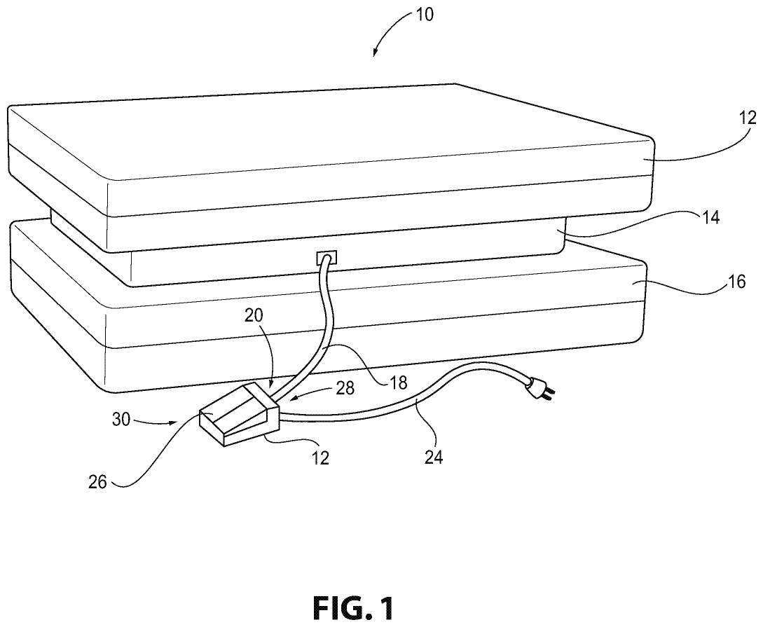

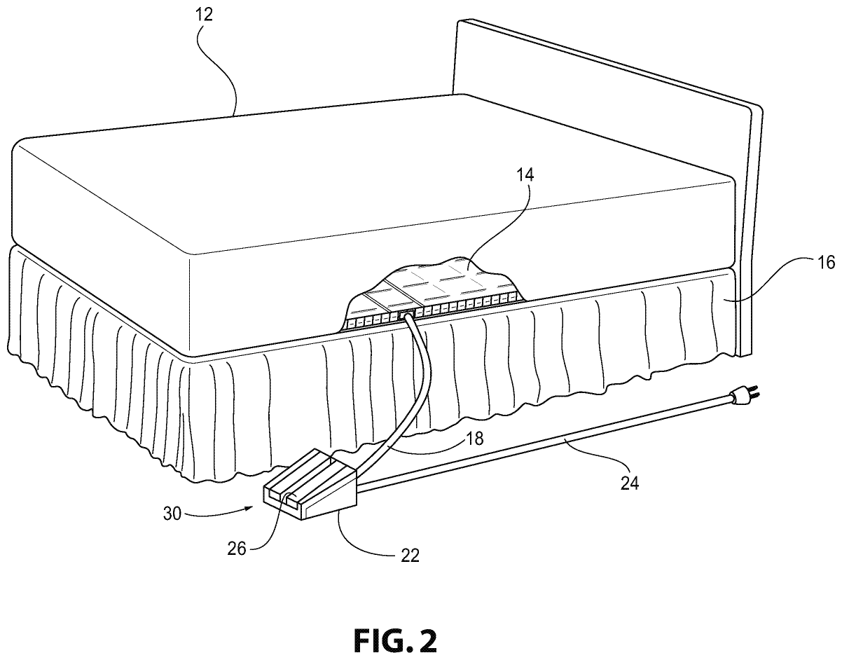

Referring in particular to FIGS. 1-3, in a first aspect the present invention provides an apparatus, generally designated 10, for lifting a mattress 12 so as to make changing bed linens less strenuous. The apparatus 10 comprises a generally rectangular inflatable member 14 that is disposed between a mattress 12 and a supporting structure 16 of a bed in an unsecured manner so as to make changing of such bed linens easy. A hosel8 is in fluid engagement at a first end thereof with the inflatable member 14 and an air pump 22 is engaged with a second end of the hose 18 for providing up to about 0.25 PSI of air for inflating the inflatable member 14 to a substantially uniform pressure throughout an entire perimeter of such inflatable member.

In a presently preferred embodiment a power source 24 is connected to the air pump 22 for providing power to operate the air pump 22 and a switch 26 is disposed between the power source 24 and the air pump 22 for activating and deactivating the air pump 22. A valve 28 is disposed in one of the hose 8 and the air pump 22 for controlling inflation and deflation of the inflatable member 14. In an embodiment of the invention a vent, generally designated 20, is disposed in one of the inflatable member 14, air pump 22, and the fluid 8 hose 8 for venting the inflatable member 14 as necessary. It should be mentioned that such supporting structure 16 is generally a box spring 6; however, there may be some instances 5 where something other than a box spring 6 is used as a supporting structure 16 for the mattress 12.

Referring in particular to FIGS. 1-3, in a second aspect of the present invention there is provided in combination with a box spring 6 the improvement comprising an apparatus 10 for lifting a mattress 12 so as to eliminate a need for physically lifting and manipulating a heavy mattress 12 during the bed making process. Such apparatus 10 includes a generally rectangular inflatable member 14 engage able with said box spring 16 and disposed between said box spring 16 and such mattress 12. Such inflatable member 14 is disposed in an unsecured manner with the mattress so as to make changing of such bed linens easy, such inflatable member provides lifting support of such mattress 12 and wherein the inflatable member 14 is sized to support edge portions of such mattress 12. There is a pump means 12 engage able with the inflatable member 14 for providing up to about 0.25 PSI of air for inflating such inflatable member 14 to a substantially uniform pressure throughout an entire perimeter of such inflatable member, and a controller 30 engageable with the pump means 12 for controlling both inflation and deflation of the inflatable member 14.

It is envisioned that inflatable member 14 could be constructed in a number of different shapes and an arrangements which each offer different advantages. The predetermined material used to form the inflatable member 14 is one of natural rubber, synthetic rubber, plastic, nylon, or similar pliable material to be selected based on the desired physical characteristics and availability. The selected material must be a durable material that is ideal for inflatable products. It is presently preferred that such material be plastic and even more preferred that such plastic is polyvinyl chloride. Such apparatus 10 further may include a semi smooth surface which serves to stabilize the inflatable member 14 in place between the mattress 12 and the box springs 16. It should be mentioned that the present invention is disposed between the box springs and the mattress in an unsecured manner, meaning that no fasteners, such as hook and loop, snaps or other fastenings are required on the mattress and/or the inflatable member. Thus, when using the present invention the user simply tucks in the sheets and blanket between the inflated inflatable member 14 and the mattress 12. The bed linen and blankets are held in place by the weight of the mattress on the inflated inflatable member until the bed linen and blankets are secured between the mattress and box springs when the inflatable member has been fully deflated.

There are no connectors of any kind between the mattress, the air bladder and the box springs. This feature is important for two reasons: (a) older mattresses were designed to be flipped or turned over every six to twelve months to promote even wear. However, the new generation of thick and heavy mattresses, particularly the King and Queen size mattresses are designed to be rotated horizontally 180 degrees every three to six months. These new mattresses are not designed to be turned over or flipped. The inflated air bladder of the present invention enables the user to easily rotate these large and heavy mattresses. (b) When making a bed, users often find it is helpful to slide 10 the mattress a little bit one way or the other in order to position the tightly fitted contour bottom sheet on the mattress. The inflated air bladder of the present invention allows the operator to easily slide the mattress about on the inflated air bladder.

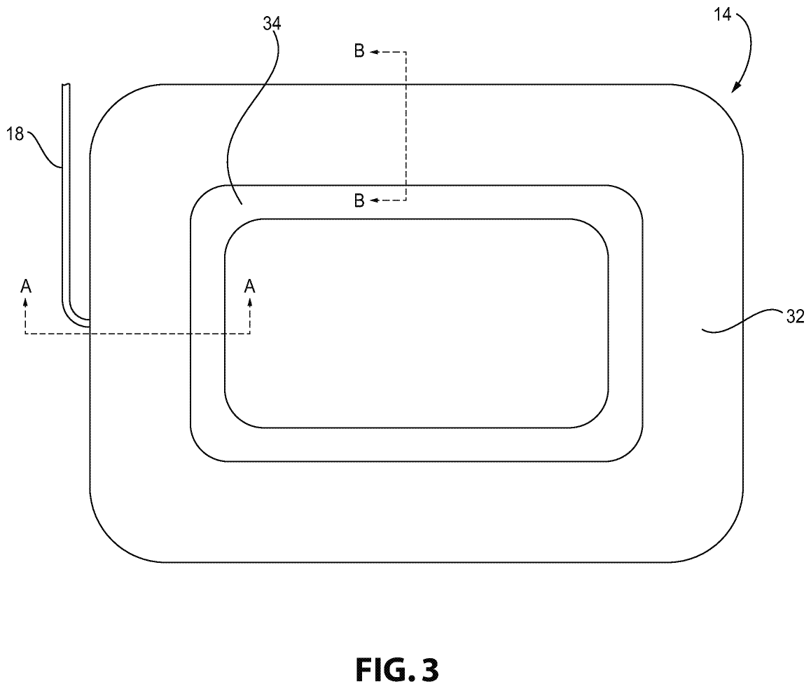

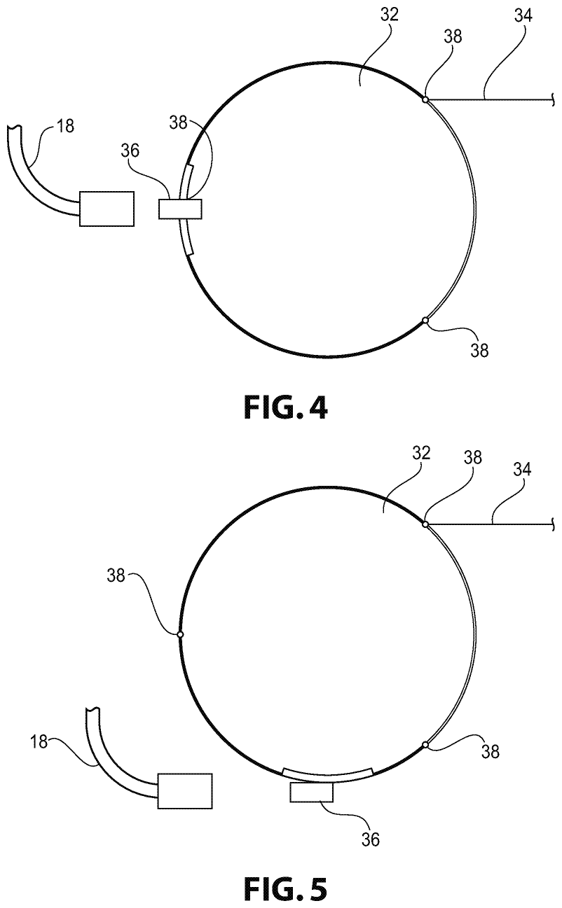

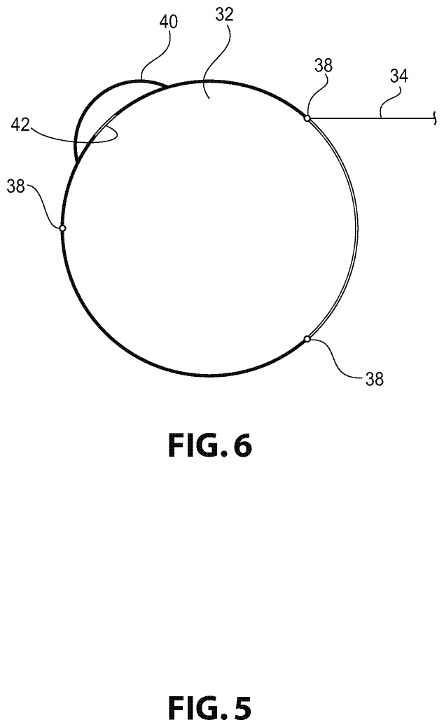

Referring to FIGS. 3-5, inflatable member 14 is shown have a generally circular cross section about its perimeter. FIG. 3-5 show the inflatable member 14 having a twelve (12) inch diameter about its outer ring 32. Inside the outer ring is disposed a gusset panel 34 which prevents sagging of some mattresses to aid in proper fitting of the sheets. In FIG. 4 the hose 18 is shown with the connector 36 disposed at a weld seam 38 on the outer ring 32 of inflatable member 14. In FIG. 5 the hose 18 is shown with the connector 36 disposed at the bottom wall surface of the outer ring 32 of inflatable member 14.

Referring to FIG. 6, shown is a cross section of the outer ring 32 of inflatable member 14 with a peripheral bulge 40. The peripheral bulge 40 is disposed on and around the upper surface of the outer ring 32 of inflatable member 14 so that it is configured to contact the bottom surface of the mattress 12 and keep sheets in place there between when inflated. The peripheral 40 is in fluid communication with the outer ring 32 of inflatable member 14 via a plurality of perforations 42. The peripheral bulge 40 helps create a more secure and easier to access functional space for holding tucked sheets between the mattress 12 and the peripheral bulge 40. It is envisioned that the peripheral bulge 40 could be included in any of the embodiments of inventions disclosed herein.

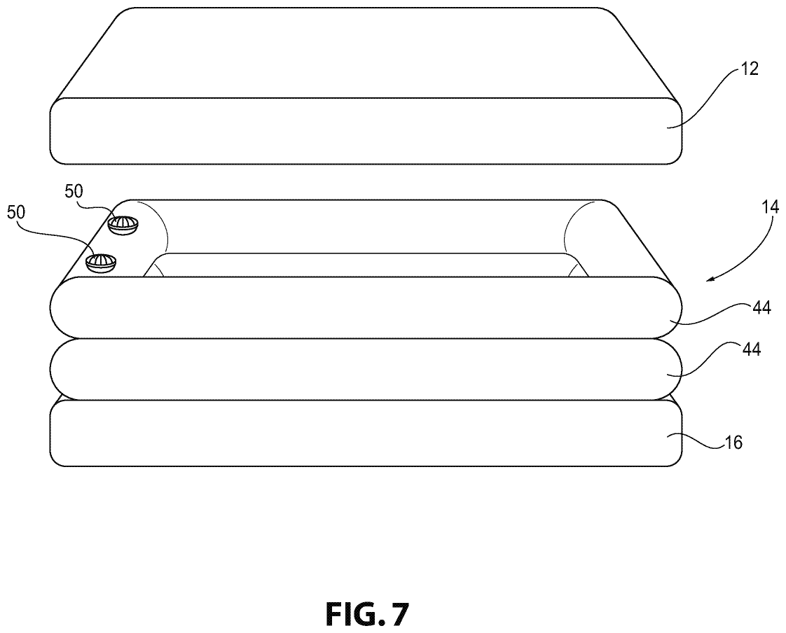

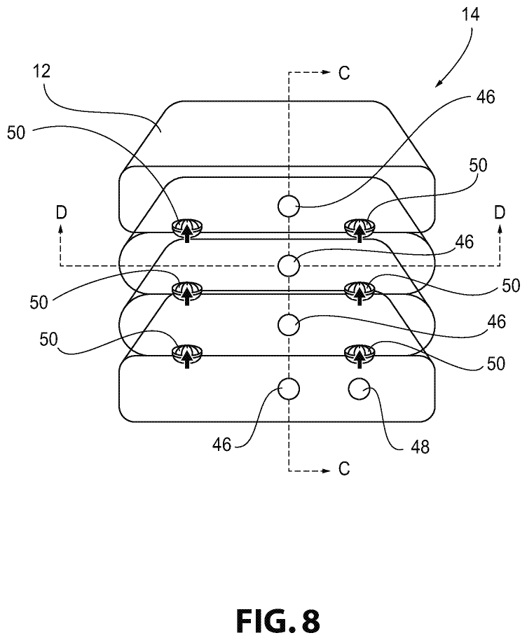

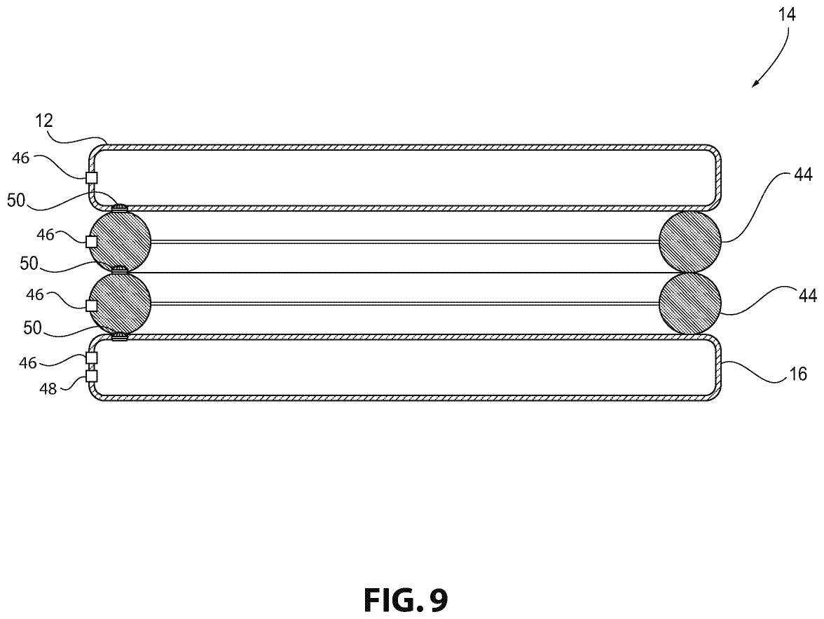

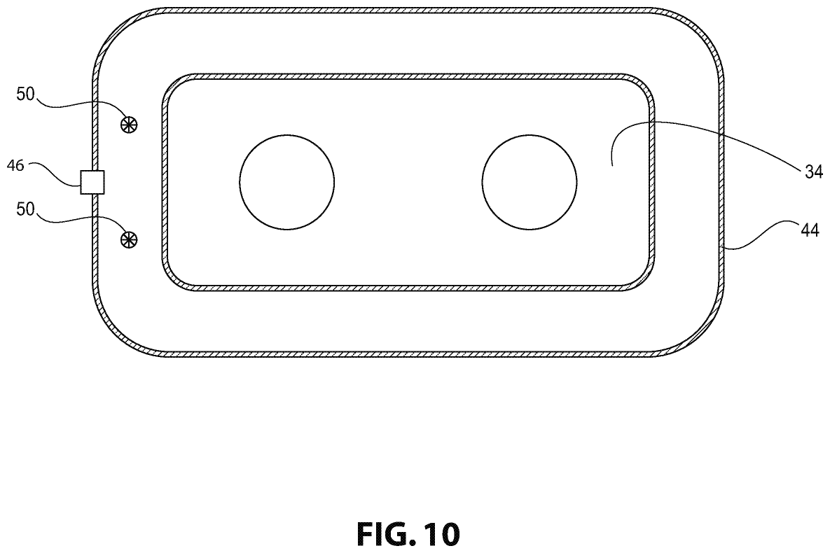

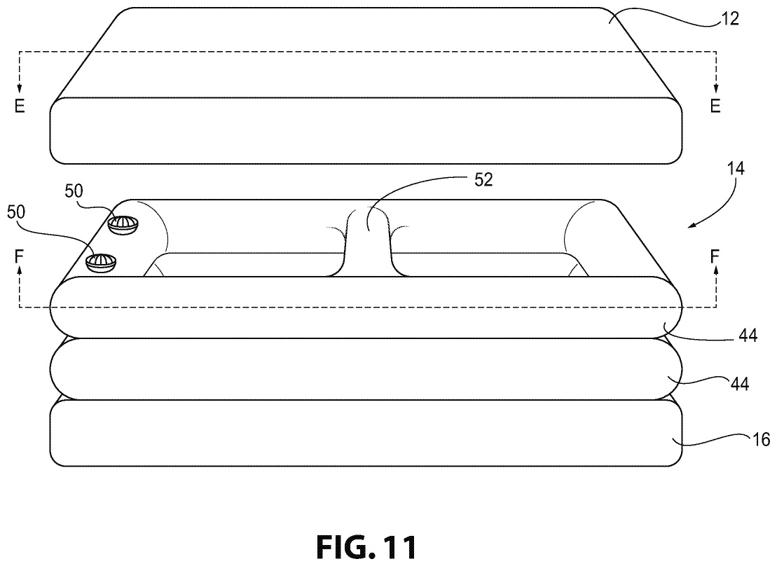

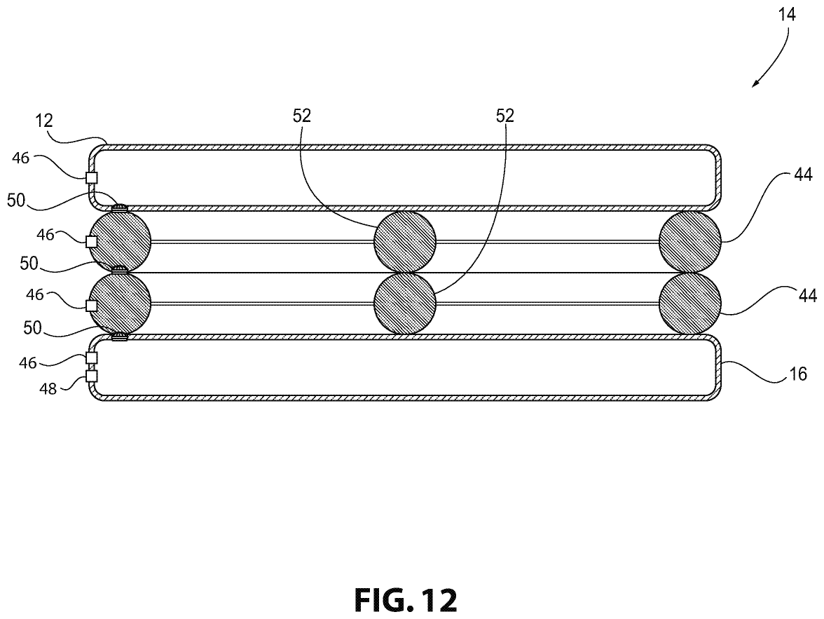

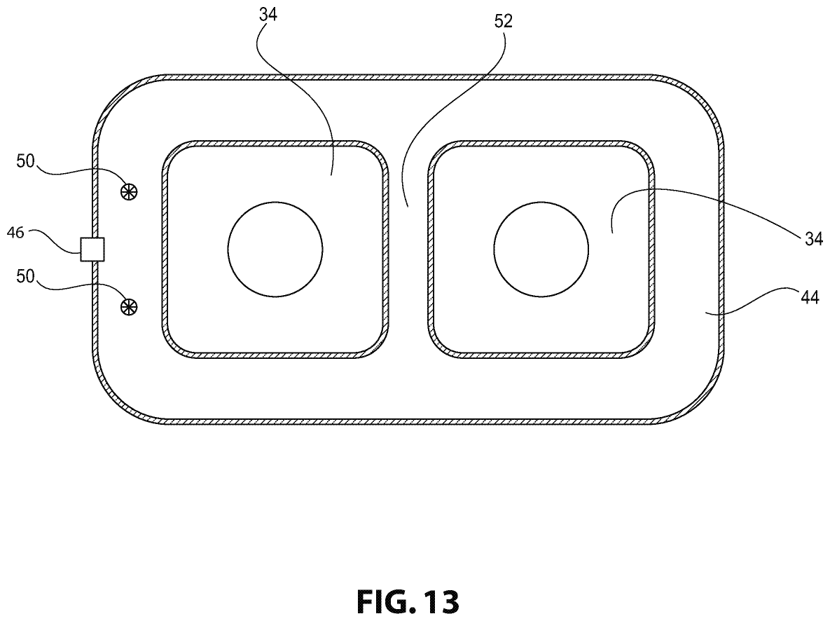

Referring now to FIGS. 7-13, in several preferred embodiments the inflatable member 14 is constructed of stacked layers 44 in order lift the mattress 12 with a lower volume of air compared to a single layer lifting to the same height. In these embodiments the mattress 12 and box spring 16 may be integrated with the inflatable member 14. Each layer 44, box spring 16, and mattress 12 includes a dump valve 46 for releasing the air pressure independently in each. The box spring 16 also includes a one way fill valve for controlling the air from air pump 22 via hose 18. Between the aforementioned layers 44, box spring 16, and mattress 12 are disposed one way relief valves 50 configured to sequentially inflate each component. In practice the air pump 22 supplies air to box spring 16 via hose 18 and fill valve 48. Once a predetermined pressure is reached, the relief valves 50 between box spring 16 and first stacked layer 44 open to allow passage of air to fill the first stacked layer 44. Then once the first stacked layer 44 reaches the predetermined pressure relief valves 50 between the two stacked layer 44 open to allow air to pass into the second stacked layer 44. Similarly relief valves 50 between second stacked layer 44 and mattress 12 open when a sufficient pressure is reached to fill the mattress 12. Once inflated the dump valve 46 can be used to deflate any or all the above layers. Referring more particularly to FIGS. 11-13, this embodiment of the invention includes a cross member 52 in each stacked layer 44 of inflatable member 14. The cross member 52 provides additional support to mattress 12 so that it does not sag in its center. Relief valves 50 are preferably low profile one way valves that will allow the inflatable member 14 to obtain a very low profile when fully deflated.

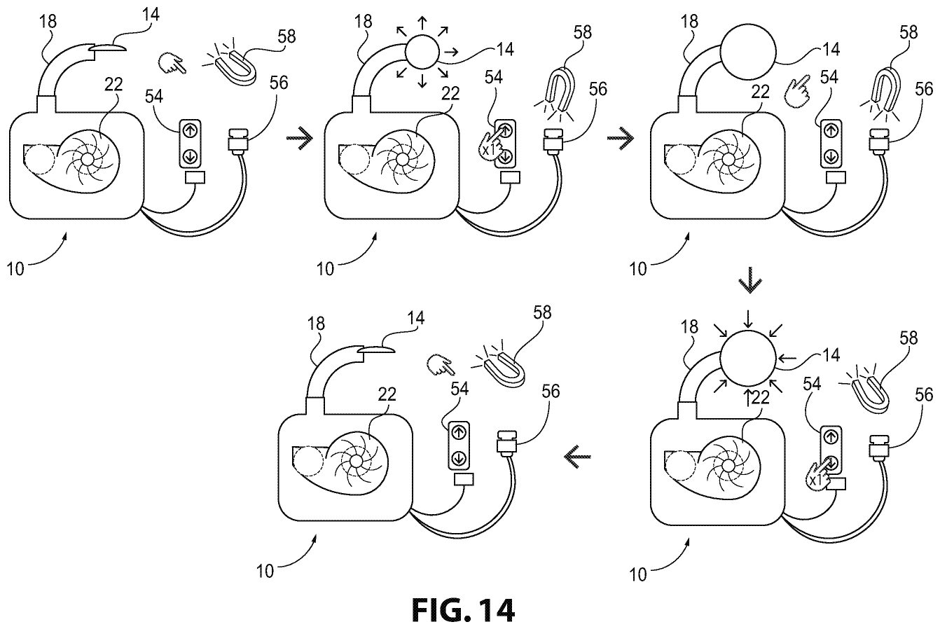

Referring to FIG. 14, an embodiment of the operation of the present invention 10 is shown. First the air pump 22 is turned on via hand controller 54 or via reed switch 56 with magnet 58. Next the inflatable member 14 is allowed to inflate. Once inflatable member 14 is sufficiently inflated, 0.25 PSI in a preferred embodiment, the air pump turns off. Next when it is desired to deflate the inflatable member 14 the hand controller 54 is manipulated or the magnet 58 is removed from the reed switch 56 to open at least one dump valve 28 and/or reverse the air pump. This results in inflatable member 14 deflating. A wireless or infrared connected controller may be used in place of or in conjunction with the hand controller 54 or reed switch 56.

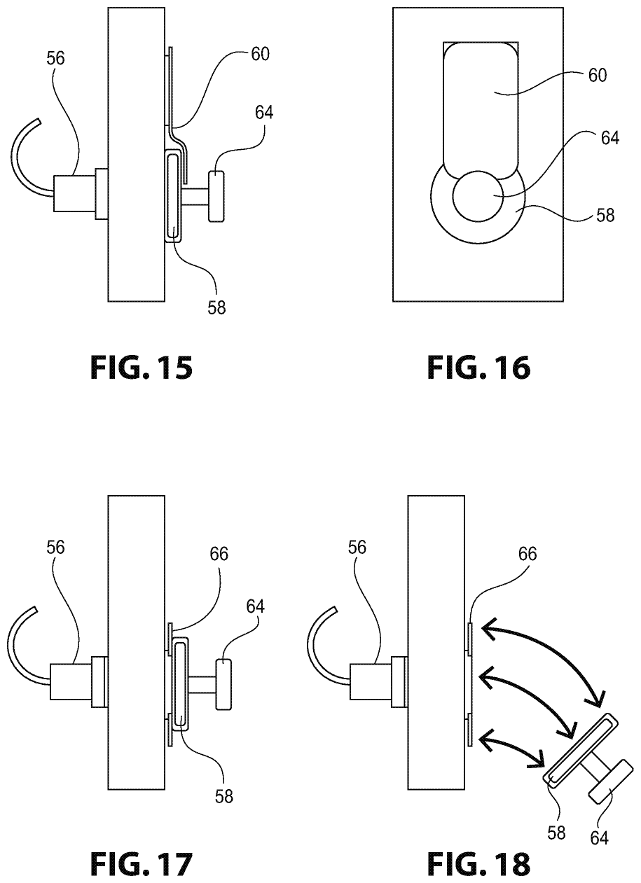

Referring to FIGS. 15-18, in several embodiments it is envisioned that a hidden reed switch 56 could be used with a separate magnet 58 to control the inflation and deflation of the inflatable member 14. This would allow only certain persons such a house keeping staff to actuate the reed switch 56. Referring more specifically to FIGS. 15 and 16, a curved metal plate 60 is attached to housing 62 with a reed switch 56 disposed inside of the housing. A magnet 58 with a knob 64 is configured to be received by curved metal plate 60 so that reed switch 56 is switched when received. The curved metal plate 60 may use a combination of mechanical engagement and/or magnetic attraction to keep knob 64 in place. Referring more specifically to FIGS. 17 and 18, a thin metal circular plate 66 is used to retain and receive magnet 58 with a knob 64. The metal circular plate 66 can be attached to housing 62 via double side tape or another fastener.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

What is claimed is:

1. An apparatus for lifting a mattress, said apparatus comprising:
(a) a generally rectangular ring shaped inflatable member with a generally constant cross section configured to be disposed between a mattress and a supporting structure of a bed in an unsecured manner;
(b) an air pump in fluid communication with said inflatable member, said air pump configured to inflate said inflatable member to a substantially uniform pressure throughout an entire perimeter of said inflatable member;
(c) a power supply in electrical communication with said air pump for providing power to operate said air pump;
(d) a switch in electrical communication between said power supply and said air pump configured for activating and deactivating said air pump; and
(e) a valve configured to control both inflation and deflation of said inflatable member.

2. The apparatus of claim 1, wherein said switch is a reed switch.

3. The apparatus of claim 1, wherein said switch is a reed switch which is configured to be normally open.

4. The apparatus of claim 2, further comprising a magnet, and clip configured to receive the magnet in a position so that a magnetic field of the magnet is applied to the reed switch.

5. The apparatus of claim 1, wherein said switch is configured to be operated via a wirelessly connected remote control.

6. The apparatus of claim 1, wherein the generally rectangular ring shaped inflatable member further comprises an inflatable cross member that bisects the ring shape of the inflatable member.

7. The apparatus of claim 1, wherein the generally rectangular ring shaped inflatable member further comprises an inflatable cross member with a generally constant cross section that bisects the ring shape of the inflatable member.

8. The apparatus of claim 1, wherein said inflatable member further comprises a textured surface configured to keep said inflatable member in place between the mattress and the supporting structure.

9. The apparatus of claim 1, wherein said inflatable member further comprises an inflatable peripheral bulge disposed and configured to contact the mattress when inflated.

10. The apparatus of claim 1, wherein the inflatable member comprises at least two generally rectangular ring shaped inflatable members in fluid communication with each other, and
wherein the at least two generally rectangular ring shaped inflatable members are disposed in a stacked orientation.

11. The apparatus of claim 10, wherein the at least two generally rectangular ring shaped inflatable members are connected in fluid communication via at least one one-way valve.

12. The apparatus of claim 1, wherein said supporting structure is a box spring.

13. The apparatus of claim 1, wherein said inflatable member is attached and integrated into the supporting structure.

14. An apparatus for lifting a mattress, said apparatus comprising:
(a) a generally rectangular ring shaped inflatable member with an inflatable cross member with a generally constant cross section that bisects the ring shape of the inflatable member configured to be disposed between a mattress and a supporting structure of a bed in an unsecured manner;
(b) an air pump in fluid communication with said inflatable member, said air pump configured to inflate said inflatable member to a substantially uniform pressure throughout an entire perimeter of said inflatable member;
(c) a power supply in electrical communication with said air pump for providing power to operate said air pump;
(d) a switch in electrical communication between said power supply and said air pump configured for activating and deactivating said air pump; and
(e) a valve configured to control both inflation and deflation of said inflatable member.

15. The apparatus of claim 14, wherein said inflatable member further comprises an inflatable peripheral bulge disposed and configured to contact the mattress when inflated.

16. The apparatus of claim 14, wherein the inflatable member comprises at least two generally rectangular ring shaped inflatable members in fluid communication with each other, and
wherein the at least two generally rectangular ring shaped inflatable members are disposed in a stacked orientation.

17. The apparatus of claim 14, wherein said inflatable member further comprises an inflatable peripheral bulge disposed and configured to contact the mattress when inflated, and wherein the inflatable member comprises at least two generally rectangular ring shaped inflatable members in fluid communication with each other, and
wherein the at least two generally rectangular ring shaped inflatable members are disposed in a stacked orientation.
